(19) United States
(12) Patent Application Publication
(10) Pub. No.: US 2007/0258424 A1
(43) Pub. Date: Nov. 8, 2007

(54) Method of route optimization with dual mobile node in IPv4-only network

(75) Inventors: Ranjitsinh Udaysinh Wable, Bangalore (IN); Lakshmi Prabha Gurusamy, Bangalore (IN); Sameer Kumar, Bangalore (IN); Kishore Mundra, Karnataka (IN); Syam Madanapalli, Bangalore (IN)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/585,912

(22) Filed: Oct. 25, 2006

(30) Foreign Application Priority Data
Oct. 26, 2005 (IN) 1552/CHE/2005
Sep. 6, 2006 (KR) 2006-85890

(51) Int. Cl. H04Q 7/24

(52) U.S. Cl. 370/338

(57) ABSTRACT

A method of achieving route optimization (RO) when a dual capable mobile Internet protocol version 6 (MIPv6) mobile node is connected with an IPv4-only network allows RO of packets to traverse a shorter route than the default one through the home agent (HA) using bidirectional tunneling, and leads to better bandwidth utilization. The method of RO with a dual MIPV6 node in an IPV4-only network includes updating the HA with an IPv4 address of the MN and deregistering a binding update (BU) with a corresponding node (CN) via the HA; informing the CN about its IPv4 address and receiving the CN's IPv4 address in reply; checking reachability of the CN in its IPv4 address using an IPv6-in-IPv4 tunnel; and sending and receiving Ipv6 data packets to/from the CN using a v4 tunnel.

### CROSS-REFERENCE TO RELATED APPLICATION

This application claims the benefit of Korean Patent Application No. 2006-85890, filed on Sep. 6, 2006 in the Korean Intellectual Property Office, and Indian Patent Application No. 1552/CHE/2005, filed on Oct. 26, 2005 in the Office of the Controller General of Patents, Designs and Trademarks, the disclosures of which are incorporated herein in their entirety by reference.

### BACKGROUND OF THE INVENTION

1. Field of the Invention

Aspects of the present invention relate to mobile communication, and more particularly, to a method of route optimization when a dual capable mobile IPv6 (MIPv6) mobile node is connected with an IPv4-only network.

2. Description of the Related Art

Dual or dual capable mobile node, router, or the like indicate that these support both Internet Protocol version 6 (IPv6) and Internet Protocol version 4 (IPv4). An IPv4-only network refers to a network that provides or supports only an IPv4 service. Also, IPv6-in-IPv4 tunneling or IPv6-over-IPv4 tunneling refers to IPv4 tunneling which encapsulates an IPv6 packet using a header that uses an IPv4 address.

Route optimization (RO) allows packets to traverse a shorter route than a default route traversing a home agent (HA) by using bidirectional tunneling, and leads to better bandwidth utilization.

Currently, the route optimization (RO) is not available when a dual capable mobile IPv6 mobile node is connected with an IPv4-only network.

References directed to related arts are as follows.
Ryuji Wakikawa, Vijay Devarapalli, Carl E. Williams, “IPv4 Care-of Address Registration”, draft-wakikawa-nemo-v4tunnel-01.txt
V. Devarapalli, R. Wakikawa, A. Petrescu, P. Thubert, “Network Mobility (NEMO) Basic Support Protocol”, RFC 3963, January 2005.
D. Johnson, C. Perkins and J. Arkko, “Mobility Support in IPv6”, RFC 3775, June 2004.
Deering S. and R. Hinden, “Internet Protocol, Version 6 (IPv6) Specification”, RFC 2460, December 1998.

In FIG. 1, a related art communication path between a mobile node (MN) and a correspondent node (CN) is described, wherein the MN is connected with an IPv4-only network. Using existing solutions, communication between the mobile node (MN) 26 and the correspondent node (CN) 18 is only possible using bidirectional tunneling via a home agent (HA) 12.

When the MIPv6 capable dual MN 26 enters the IPv4-only network 22, the MN 26 obtains an IPv4 Address for itself from the IPv4-only network 22.

On not receiving any router advertisement (RA), MN 26 realizes that the network 22 is an IPv4-only network. MN 26 sends a binding update (BU) containing the obtained IPv4 address to its HA 12.

On receiving the IPv4 address of the MN 26 by the HA 12, a bidirectional tunnel 28 is established between the HA 12 and the MN 26 in the IPv4-only network 22. All packets 30 to and from the MN 26 go via the established bidirectional tunnel 28.

However there are the following limitations to the above.

1. All packets 30 to and from MN 26 traverse via the bidirectional tunnel 28 between HA 12 and MN 26. Accordingly, overhead is added to the HA 12.

2. If the HA 12 does not support the bidirectional tunnel 28 (IPv6-over-IPv4 tunneling), the MN 26 cannot communicate with any of the CNs such as CN 18.

### SUMMARY OF THE INVENTION

Aspects of the present invention include a method of route optimization (RO) in which direct packet delivery is possible between a mobile node (MN) and a correspondent node (CN) so as to avoid a bidirectional tunnel path via a home agent (HA), when a dual capable mobile IPv6 node moves to an IPv4-only network.

Aspects of the present invention also include a computer readable recording medium having recorded thereon a program for executing the method of RO described above.

According to an aspect of the present invention, a method of route optimization with dual MIPV6 node (MN) in IPV4-only network includes: updating the HA with an IPv4 address of the MN and deregistering a previous BU with the CN via the HA; informing the MN's IPv4 address to the CN and getting the CN's IPv4 address in reply; checking reachability of CN by CN's IPv4 address using an IPv6-in-IPv4 tunnel; and sending and receiving IPv6 data packets to/from the MN and the CN using the IPv6-in-IPv4 tunnel.

Updating the HA with the IPv4 address involves the MN sending a BU packet to the HA, encapsulated in an IPv4 header. The BU packet has the MN's global visited IPv4 address as an outer source address, the HA's IPv4 address as an outer destination address, and a normal BU as an inner packet.

On receiving the BU packet, the HA removes binding cache, if any, existing for the said MN and stores the required tunneling parameters. The HA tunnels the BU packet to and from the CN to the MN in an IPv4 packet and the MN tunnels the packet destined to the CN using HA's IPv4 address. Deregistering the previous BU with the CN via the HA involves the MN deregistering the previous binding update with the CN by sending the normal BU to the CN encapsulated in the V4 packet via HA. The said IPv4 packet has the MN's visited IPv4 global address as an outer source address, the HA's IPv4 address as an outer destination as address, the MN's IPv6 home address (HoA) as an inner source address, the CN's IPv6 address as an inner destination address and the normal BU.

On receiving the IPv4 packet, the CN removes a binding cache thereof for the MN and start communicating with MN using the MN's HoA. Informing the CN with the MN's IPv4 address involves the MN sending a packet to the CN via the HA, including the MN's IPv4 address and asking for the CN's IPv4 address. The CN stores the MN's IPv4 address to be used for data packet tunneling. The CN replies back with the CN's IPv4 address if it is dual capable or router address which is dual and on a link with the CN. Checking the reachability of the CN through the CN's IPv4 address involves the MN sending a direct v6-in-v4 packet destined to the CN. On receiving the packet, the CN sends response packet directly to the MN. Sending and receiving The IPv6 data packets to/from the MN and the CN using IPv4 tunnel involves the MN starting to send data packets to the CN tunneled in IPv4 packet once the reachability is verified. In return, the CN sends data packets tunneled directly to the MN's IPv4 address.

According to another aspect of the present invention, a method of route optimization with a dual mobile node (MN) capable of both Internet Protocol version (IPv) 4 and IPv6 in an IPv4-only network includes: obtaining an IPv4 address of the MN and registering the IPv4 address of the MN in a home agent (HA); informing the IPv4 address of the MN to a correspondent node (CN); receiving an IPv4 address of the CN from the CN; checking reachability of the CN using IPv4 tunneling which encapsulates an IPv6 packet into a header that uses the IPv4 addresses of the MN and the CN; and performing data communication with the CN using the IPv4 tunneling.

The registering of the IPv4 address of the MN in the HA may be performed using a binding update.

The informing of the IPv4 address of the MN to the CN may include sending an IPv4 tunneling packet, which has a visited global IPv4 address of the MN as an outer source address, an IPv4 address of the HA as an outer destination address, an IPv6 home address of the MN as an inner source address, an IPv6 address of the CN as an inner destination address, and the IPv4 address of the MN, to the HA.

The receiving of the IPv4 address of the CN from the CN may be performed using the HA.

The receiving of the IPv4 address of the CN from the CN may include receiving an IPv4 address of a router connected to the CN instead of the IPv4 address of the CN, when the CN does not support the IPv4 tunneling.

The checking of reachability of the CN may include sending a packet, which has a visited global IPv4 address of the MN as an outer source address, the IPv4 address of the CN as an outer destination address, an IPv6 home address of the MN as an inner source address, an IPv6 address of the CN as an inner destination address, and a value showing that the packet is a reachability checking message to a mobility header, to the CN.

The checking of reachability of the CN may further include receiving a message packet, which has the IPv4 address of the CN as an outer source address, a visited global IPv4 address of the MN as an outer destination address, an IPv6 address of the CN as an inner source address, an IPv6 home address of the MN as an inner destination address, and a value showing that the message packet is a reachability informing message to a mobility header, from the CN.

According to another aspect of the present invention, a method of route optimization between a dual mobile node (MN) capable of both Internet Protocol version (IPv) 4 and IPv6, a correspondent node (CN), and a home agent (HA), when the MN is in an IPv4-only network, the method includes: exchanging IPv4 addresses through the HA; and communicating directly between the MN and the CN without the HA.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 shows a related art communication path between a mobile node (MN) and a correspondent node (CN) when the MN is connected with an IPv4-only network.

FIG. 2 illustrates new message exchanges via a home agent (HA) and a subsequent direct delivery of data packets.

FIG. 3 illustrates message flow sequences of an aspect of the present invention when an MN is attached to an IPv4-only network.

FIGS. 4A and 4B show Mobility Header type packet formats of messages according to aspects of the present invention.

### DETAILED DESCRIPTION OF THE EMBODIMENTS

Reference will now be made in detail to aspects of the present invention, mainly methods of route optimization with dual mobile node in IPv4-only network, examples of which are illustrated in the accompanying drawings, wherein like reference numerals refer to the like elements throughout. The aspects are described below in order to explain the present invention by referring to the figures.

When a mobile node (MN) gets connected or attached to an IPv4-only network, all the traffic to and from the MN should traverse via a bidirectional tunnel to a home agent (HA). Thus, overhead is added to the HA. Aspects of the present invention allow packets to and from the MN to go directly to a correspondent node (CN) using an IPv6-in-IPv4 tunnel. Accordingly, the MN must be dual capable.

In aspects of the present invention, a direct packet delivery (Route Optimization) between an MN and CN avoids the bidirectional tunnel path via the HA, when a dual capable MIPv6 node moves or attaches to an IPv4-only network. Route optimization (RO) makes use of the IPv4 capability of a CN or a router that is linked with the CN (which can act on behalf of the CN) by forming IPv6-in-IPv4 tunnels. IPv6 packets originating from the MN are encapsulated/tunneled inside an IPv4 header and decapsulated by a CN/Router (on behalf of CN) on reception.

We assume that the MN, CN and HA are dual capable. Instead of the CN, any dual router connected with the CN can act on the CN's behalf. Similarly, instead of the HA, any dual router supporting the IPv6-over-IPv4 tunnel, which is present within a Home Administrative Domain of the Home Network, can act on behalf of the HA. In addition, the MN is expected to have an IPv4 address of the HA.

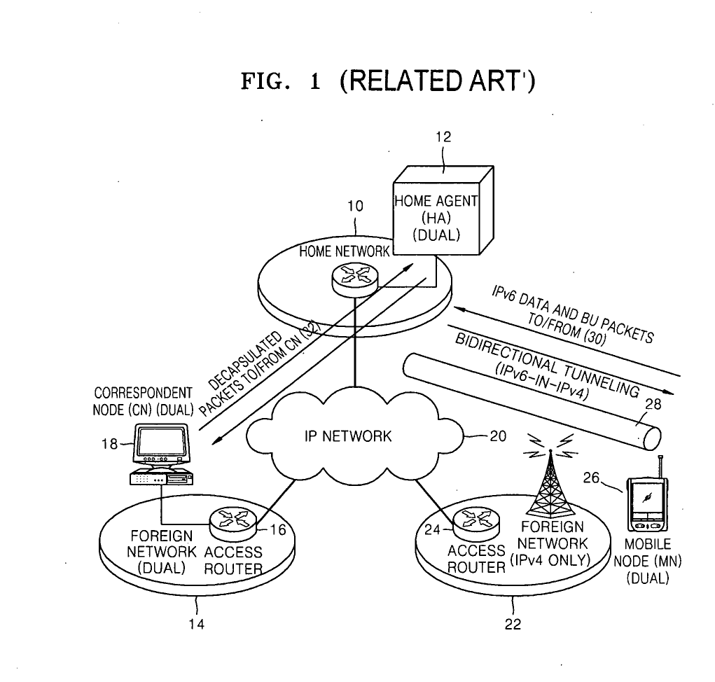

As discussed above, FIG. 1 shows packet exchanges between an MN 26 and an HA 12, and between the MN 26 and a CN 18 via the HA 12, when the MN 26 moves or connects to an IPv4-only network 22. FIG. 1 depicts handover of the MN 26, which is a dual capable node, from an IPv6 network (not shown) to the IPv4-only network 22.

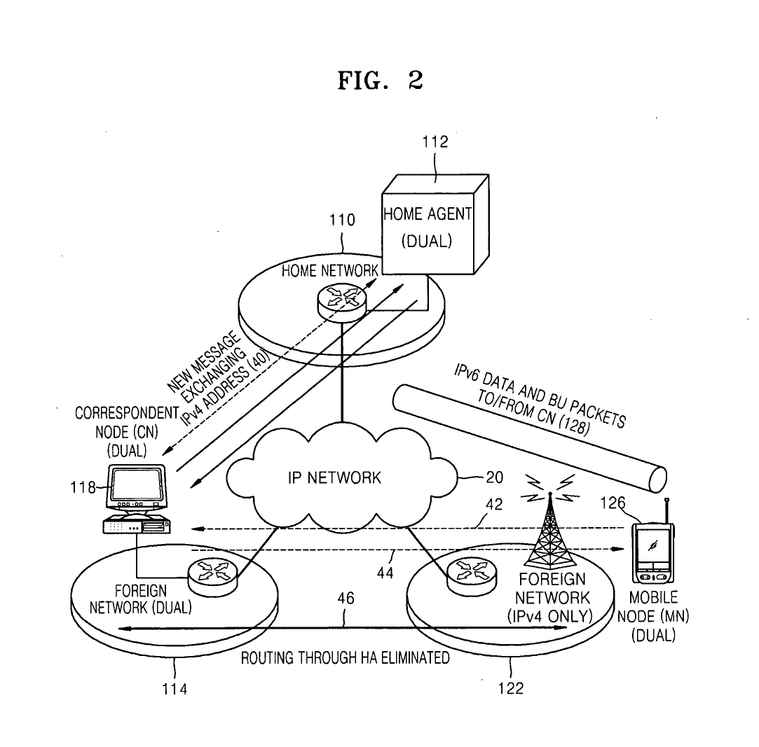

FIG. 2 shows new message exchanges 40, 42, and 44 between an and a CN 118 via an HA 112 in order to achieve route optimization (RO). As shown in FIG. 2, an IPv4 address 40 is exchanged between the CN 118 and the using a bidirectional tunnel 128 via the HA 112. Then, reachability test messages 42 and further data packets are sent directly from the to the CN 118 using IPv6-in-IPv4 tunnel 46.

Once the gets attached to an IPv4-only network 122, the gets a new IPv4 address. Then the updates its HA 112 with the new IPv4 address. Thus, the HA 112 makes a binding entry for this with the received new IPv4 address and from then on, tunnels the data packets received for the MN's (126) home address to MN's (126) new IPv4 address. The updates the CN 118, via the HA 112 about MN's new IPv4 address. Thus, the CN 118 updates its binding entry. This communication is similar to that shown in FIG. 1 using a pipe (tunnel) 28 and lines 32.

After updating the HA 112, the sends out a new message (such as 40) to the CN 112 giving the MN's (126) new IPv4 address and requesting the CN's (118) IPv4 address (if the CN is dual capable), via the HA 112. The packet containing the MN's (126) new IPv4 address is an IPv6-in-IPv4 tunnel packet. The HA 112 detunnels (or decapsulates) the IPv6-in-IPv4 tunnel packet and forwards an inner packet (IPv6 packet) to the CN 118. Then the CN 118 replies back with an IPv4 address of the CN 118 (if it is dual capable) to the MN's (126) home address (e.g., the MN's (126) IPv6 address). The reply of the CN 118 is then tunneled by the HA 112 to the MN's (126) new IPv4 address.

Once the knows the CN's IPv4 address, the does an address reachability test (42) for direct delivery of packets. After getting the reply for the address reachability test (44) from the CN 118, the starts sending data packets directly to the CN using IPv6-in-IPv4 tunnels (46). Finally, routing through the HA 112 is eliminated when data packet communication is sent via direct line 46 between the and CN 118.

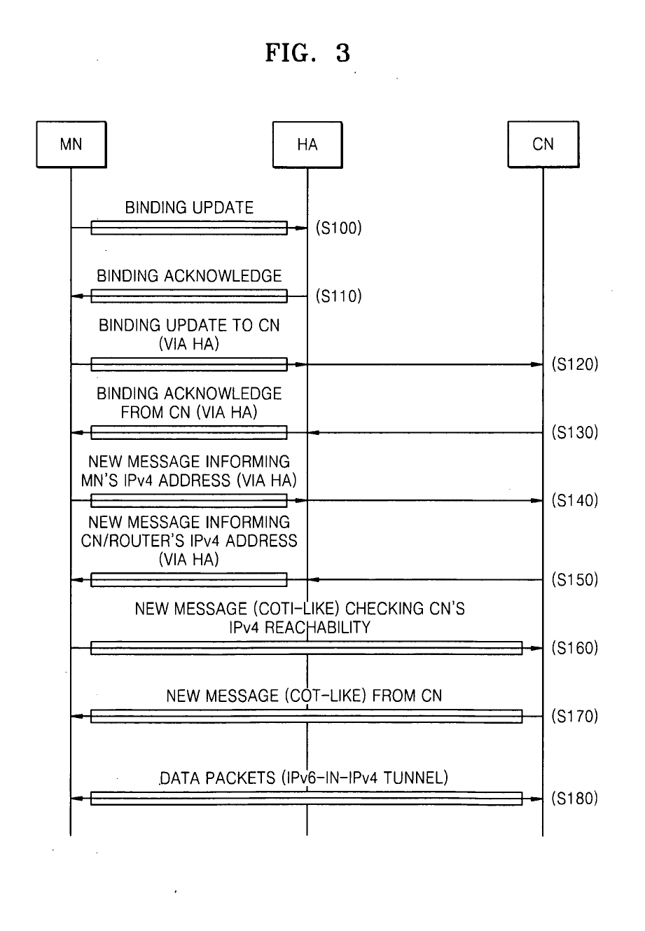

FIG. 3 shows message flow sequence according to an aspect of the present invention when the is attached to the IPv4-only network 122. Specifically, FIG. 3 shows the flow of messages between the , HA 112 and CN 118. FIG. 3 depicts tunneled and decapsulated packets differently. FIG. 3 shows the message flow sequence after the gets attached to a foreign network, such as the IPv4-only network 122, and after the receives the new IPv4 address. Lines covered with a box denote IPv6-in-IPv4 tunnel packets. Direct lines without a box show packets that are not tunneled, mainly plain packets between the CN 118 and the HA 112 (e.g., packets in IPv6).

As shown in FIG. 3, the first two packet exchanges update the HA 112 with the MN's (126) move. The tunnels a binding update to the HA 112 (operation S100). The HA 112 then tunnels a binding acknowledge to the (operation S110).

Next two packet exchanges update the CN 118 with the MN's (126) move via the HA 112. The tunnels the binding update (BU) to the HA 112, and then the HA 112 sends the binding update to the CN 118 (operation S120). The CN 118 then sends a binding acknowledge to the HA 112, and then the HA 112 tunnels the binding acknowledge to the MN 126 (operation S130).

Next two packet exchanges inform the MN's IPv4 address and request the CN 118 to give its IPv4 address via the HN 112. The tunnels a new message informing the MN's (126) IPv4 address to the HA 112, and then the HA 112 sends the new message to the CN 118 (operation S140). The CN 118 then sends a new message informing CN/Router's IPv4 address to the HA 112, and then the HA 112 tunnels the new message to the (operation S150).

Next two packet exchanges test reachability of the CN's (118) IPv4 address for direct delivery. The tunnels a new message (COTI-like) checking CN's (118) IPv4 reachability directly to the CN 118 (operation S160). The CN 118 then tunnels a new message (COT-like) directly to the (operation S170). Here, COTI stands for care-of test init and COT stands for care-of test.

Final bidirectional packet exchanges show how data packets are transmitted between the and CN 118 (operation S180). As shown, the data packets (IPv6-in-IPv4) are tunneled between and CN 118.

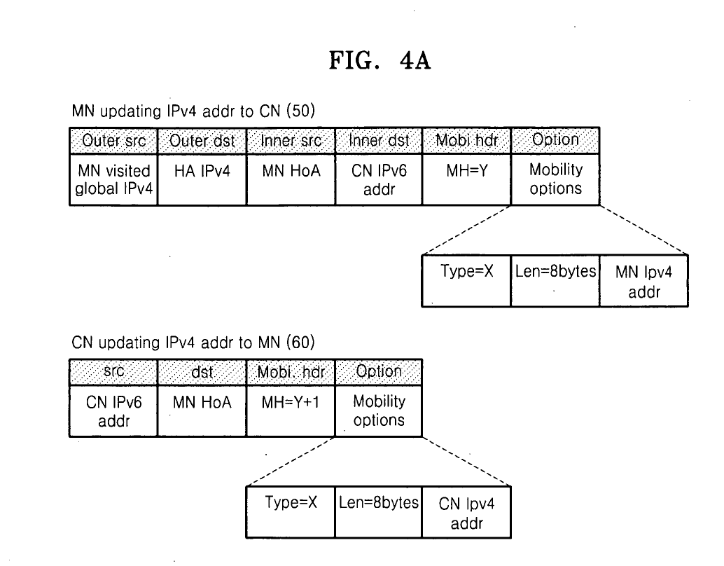

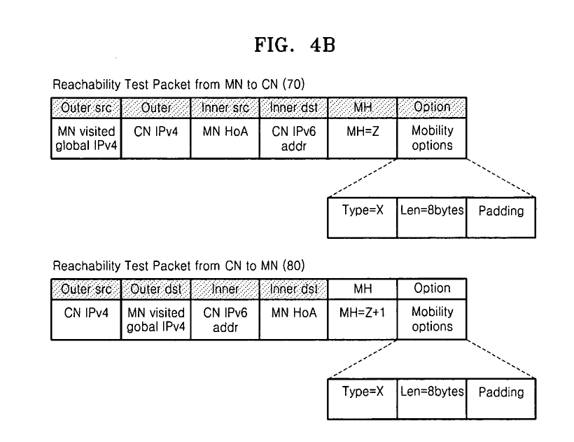

FIGS. 4A and 4B show mobility header type packet formats of messages according to aspects of the present invention. The packet formats are used when an MN moves to an IPv4-only network. FIGS. 4A and 4B show an implementation of a mobility header option. The mobility header option is a Type-Length-value option carrying an IPv4 address to and from the MN and CN. Accordingly, in FIGS. 4A and 4B, four mobility header options are defined.

As shown, first two packet formats shown in FIG. 4A denote a mobility header to inform the CN 118 about the MN's (126) IPv4 address and getting back a reply from the CN 118 with the CN's (118) IPv4 address. The formats are for exchanging IPv4 addresses from the to the CN 118 and from the CN 118 to the .

The first of the two packet formats 50 (MN updating IPv4 address to CN) includes an outer source address (an MN visited global IPv4 address), an outer destination address (an HA IPv4 address), an inner source address (an IPv6 MN HoA), an inner destination address (a CN IPv6 address), a mobile header (MH=Y), and option (mobility options with type=X, length=8 bytes, and MN IPv4 address).

The second of the two packet formats 60 (CN updating IPv4 address to MN) includes a source address (a CN IPv6 address), a destination address (an IPv6 MN HoA), a mobile header (MH=Y+1), and an option (mobility options with type=X, length=8 bytes, and CN IPv4 address).

Next two packet formats shown in FIG. 4B denote a mobility header to test reachability of the IPv4 address of the CN 118. The formats are for use in a reachability test of the IPv4 addresses from the to the CN 118 and from the CN 118 to the .

The first of the two packet formats 70 (reachability test packet from MN to CN) includes an outer source address (an MN visited global IPv4 address), an outer destination address (a CN IPv4 address), an inner source address (an IPv6 MN HoA), an inner destination address (a CN IPv6 address), a mobile header (MH=Z), and option (mobility options with type=X, length=8 bytes, and padding).

The second of the two packet formats 80 (reachability test packet from CN to MN) includes an outer source address (a CN IPv4 address), an outer destination address (an MN visited global IPv4 address), an inner source address (a CN IPv6 address), a destination address (an MN HoA), a mobile header (MH=Z+1), and an option (mobility options with type=X, length=8 bytes, and padding).

Operation of the invention using the above is as follows.

1. When a dual capable MN is connected to an IPv4-only network, the MN becomes configured using a visited IPv4 address (global) from a router it is connected with.

2. Updating the HA with the IPv4 address, wherein:

(1) The MN sends a binding update (BU) to the HA, encapsulated in the IPv4 header.

(2) Encapsulated BU packet details include the MN's Global visited IPv4 address as an outer source address, the HA's IPv4 address as an outer destination address, and a normal BU packet as an inner packet.

(3) Upon receiving the encapsulated BU packet, HA removes a binding cache (if any) existing for the MN and stores the required tunneling parameters (i.e., MN's IPv4 address, etc.)

(4) Then, the HA tunnels the encapsulated BU packet to and from the CN to the MN in the IPv4 packet and the MN tunnels the encapsulated BU packet destined to the CN using the HA's IPv4 address.

3. Deregistering BU with the CN (Via the HA):

(1) The MN should deregister its previous binding update with the CN, by sending a normal BU to the CN encapsulated in the IPv4 packet (via the HA).

(2) Encapsulated normal BU packet details include the MN's visited IPv4 address (global) as an outer source address, the HA's IPv4 address as an outer destination address, the MN's IPv6 Home Address (HoA) as an inner source address, the CN's IPv6 address as an inner destination address, and the normal BU.

(3) Upon receiving this encapsulated normal BU packet, the CN removes the packet's binding cache for the MN and starts communicating with the MN using the MN's HoA.

4. Updating the CN with the IPv4 address:

(1) The MN sends a packet to the CN via the HA, including the MN's IPv4 address and requests the CN's IPv4 address.

(2) The CN stores the MN's IPv4 address so that the MN's IPv4 address may be used for data packet tunneling.

(3) The CN replies with its IPv4 address (if it is dual capable) or with an address of a router which is dual and linked with the CN.

5. Checking reachability of the CN through its IPv4 address:

(1) The MN sends a direct v6-in-v4 packet destined to the CN (Care-of Test Init (COTI like)).

(2) Upon receiving this packet, the CN sends a response packet directly to the MN (Care-of Test (COT like)).

6. IPv6 data packets

(1) Once the reachability is verified, the MN starts sending data packets to the CN tunneled in the IPv4 packet.

(2) Similarly, the CN sends data packets tunneled directly to MN's IPv4 address.

Aspects of the present invention can also be embodied as computer (including any device that has an information processing function) readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

In the method of RO according to aspects of the present invention, data packet delivery between the MN and the CN is performed directly through the IPv4 tunnel without traversing the HA. Accordingly, delivery delay can be avoided and overhead of the HA can be reduced, thereby increasing delivery efficiency and bandwidth.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A method of route optimization with a dual MIPv6 (mobile Internet protocol version 6) node (MN) in an IPv4-only network, comprising:
updating a home agent (HA) with an IPv4 address of the MN and deregistering a previous Binding Update (BU) with a correspondent node (CN) via the HA;
informing the CN about the MN's IPv4 address and receiving the CN's IPv4 address in reply;
checking reachability of the CN by the CN's IPv4 address using an IPv6-in-IPv4 tunnel; and
sending and receiving an IPv6 data packet to/from the MN and the CN using the IPv6-in-IPv4 tunnel.

2. The method of claim 1, wherein updating of the HA comprises the MN sending a BU packet to the HA, encapsulated in an IPv4 header.

3. The method of claim 2, wherein the BU packet has the MN's global visited IPv4 address as an outer source, the HA's IPv4 address as an outer destination, and a normal BU as an inner packet.

4. The method of claim 2, wherein upon receiving the BU packet, the HA removes a binding cache, if any exists, for the MN and stores required tunneling parameters.

5. The method of claim 2, wherein the HA tunnels the BU packet to and from the CN to the MN in an IPv4 packet and the MN tunnels all packets destined to the CN using the HA's IPv4 address.

6. The method of claim 1, wherein deregistering the previous BU with the CN via the HA comprises the MN deregistering the previous BU with the CN by sending a normal BU to the CN encapsulated in an IPv4 packet via the HA.

7. The method of claim 6, wherein the IPv4 packet has the MN's visited v4 global address as an outer source address, the HA's IPv4 address as an outer destination address, the MN's IPv6 Home Address (HoA) as an inner source address, the CN's IPv6 address as an inner destination address, and a BU.

8. The method of claim 6, wherein upon receiving the IPv4 packet, the CN removes a binding cache thereof for the MN and starts communicating with the MN using the MN's Home Address (HoA).

9. The method of claim 1, wherein informing of the CN comprises the MN sending a packet to the CN via the HA, including the MN's IPv4 address and asking for the CN's IPv4 address.

10. The method of claim 9, wherein the CN stores the MN's IPv4 address that is to be used for data packet tunneling.

11. The method of claim 9, wherein the CN replies with the CN's IPv4 address if the CN is dual capable or has a router address which is dual and linked to the CN.

12. The method of claim 1, wherein the checking of the reachability of the CN comprises the MN sending a direct v6-in-v4 packet destined to the CN.

13. The method of claim 12, wherein in response to receiving the packet, the CN sends a response packet directly to the MN.

14. The method of claim 1, wherein the sending and receiving of the IPv6 data packet comprises the MN starting to send IPv6 data packet to the CN tunneled in the IPv4 packet once the reachability is verified.

15. The method of claim 14, wherein, in return, the CN sends an IPv6 data packet tunneled in an IPv4 packet directly to the MN's IPv4 address.

16. A method of route optimization with a dual mobile node (MN) capable of both Internet Protocol version (IPv) 4 and IPv6 in an IPv4-only network, the method comprising:
obtaining an IPv4 address of the MN and registering the IPv4 address of the MN in a home agent (HA);
informing a correspondent node (CN) about the IPv4 address of the MN;
receiving an IPv4 address of the CN from the CN;
checking reachability of the CN using IPv4 tunneling which encapsulates an IPv6 packet into a header that uses the IPv4 addresses of the MN and the CN; and
performing data communication with the CN using the IPv4 tunneling.

17. The method of claim 16, wherein the registering of the IPv4 address of the MN in the HA is performed using a binding update.

18. The method of claim 16, wherein the informing of the CN about the IPv4 address of the MN comprises sending an IPv4 tunneling packet, which has a visited global IPv4 address of the MN as an outer source address, an IPv4 address of the HA as an outer destination address, an IPv6 home address of the MN as an inner source address, an IPv6 address of the CN as an inner destination address, and the IPv4 address of the MN, to the HA.

19. The method of claim 16, wherein the receiving of the IPv4 address of the CN from the CN is performed using the HA.

20. The method of claim 16, wherein the receiving of the IPv4 address of the CN from the CN comprises receiving an IPv4 address of a router connected to the CN instead of the IPv4 address of the CN, when the CN does not support the IPv4 tunneling.

21. The method of claim 16, wherein the checking of reachability of the CN comprises sending a packet, which has a visited global IPv4 address of the MN as an outer source address, the IPv4 address of the CN as an outer destination address, an IPv6 home address of the MN as an inner source address, an IPv6 address of the CN as an inner destination address, and a value showing that the packet is a reachability checking message to a mobility header, to the CN.

22. The method of claim 21, wherein the checking of reachability of the CN further comprises receiving a message packet, which has the IPv4 address of the CN as an outer source address, a visited global IPv4 address of the MN as an outer destination address, an IPv6 address of the CN as an inner source address, an IPv6 home address of the MN as an inner destination address, and a value showing that the message packet is a reachability informing message to a mobility header, from the CN.

23. A computer readable medium recorded with a program for a computer to execute a method of route optimization with a dual MIPV6 node (MN) in an IPV4-only network, wherein the computer executes the method comprising:
updating a home agent (HA) with an IPv4 address of the MN and deregistering a Binding Update (BU) with a correspondent node (CN) via the HA;
informing the CN about the MN's IPv4 address and receiving the CN's IPv4 address in reply;
checking reachability of the CN by the CN's IPv4 address using an IPv6-in-IPv4 tunnel; and
sending and receiving IPv6 data packet to/from the MN and the CN using an IPv6-in-IPv4 tunnel.

24. A computer readable medium recorded with a program for a computer to execute a method of route optimization with a dual MN capable of both IPv4 and IPv6 in an IPv4-only network, wherein the computer executes the method comprising:
obtaining an IPv4 address of the MN and registering the IPv4 address of the MN in a home agent (HA);
informing a correspondent node (CN) about the IPv4 address of the MN;
receiving an IPv4 address of the CN from the CN;
checking reachability of the CN using IPv4 tunneling which encapsulates an IPv6 packet into a header that uses the IPv4 addresses of the MN and the CN; and
performing data communication with the CN using the IPv4 tunneling.

25. A method of route optimization between a dual mobile node (MN) capable of both Internet Protocol version (IPv) 4 and IPv6, a correspondent node (CN), and a home agent (HA), when the MN is in an IPv4-only network, the method comprising:
exchanging IPv4 addresses through the HA; and
communicating directly between the MN and the CN without the HA.

26. The method of claim 25, wherein the exchanging of the IPv4 addresses includes the MN tunneling the MN's IPv4 address to the CN through the HA and requesting the CN's IPv4 address.

27. The method of claim 25, wherein the communicating directly between the MN and the CN without the HA includes the MN and the CN communicating directly with each other by tunneling using each other's IPv4 addresses.
